(19) United States
(12) Patent Application Publication
(10) Pub. No.: US 2017/0010384 A1
(43) Pub. Date: Jan. 12, 2017

(54) Device For Detecting Weapons In A Piece Of Luggage

(71) Applicant: Carbon Team Germany GmbH, Marktheidenfeld (DE)

(72) Inventor: Markus Kreuzer, Marktheidenfeld (DE)

(21) Appl. No.: 15/206,235

(22) Filed: Jul. 9, 2016

(30) Foreign Application Priority Data
Jul. 10, 2015 (DE) 202015103628

(51) Int. Cl. G01V 5/00; G21K 1/06

(52) U.S. Cl. CPC G01V 5/0033; G21K 1/067

(57) ABSTRACT

The disclosed invention relates generally to a device for detecting weapons in a piece of luggage, which can be used in particular at airport security gates. The object of the present invention pertains to the technical field of security technology for checking persons with respect to the carrying of weapons. In particular, the invention relates to the visualization of carried bladed weapons or firearms, for instance in airport security checks.

This application claims priority from German Utility Model No. 20 2015 103 628, filed on Jul. 10, 2015 entitled ‘Device for Detecting Weapons in a Piece of Luggage’, which application is incorporated herein by reference in its entirety for all purposes.

### FIELD OF TECHNOLOGY

The present invention relates generally to a device for detecting weapons in a piece of luggage, which can be used in particular at airport security gates. The object of the present invention pertains to the technical field of security technology for checking persons with respect to the carrying of weapons. In particular, the invention relates to the visualization of carried bladed weapons or firearms, for instance in airport security checks.

### BACKGROUND

In the check-in procedure for flight passengers, the flight passenger with his/her luggage arrives at the airport and is received at the corresponding counter for the respective flight by the reception personnel of the booked airline. At the counter, the flight passenger receives his/her boarding ticket by means of which he/she is firstly enabled to enter an airport security zone and to finally enter the airplane. Moreover, the flight passenger drops off the luggage at the counter, which is then transferred to the freight space of the airplane separately. The pieces of luggage of the registered luggage are screened at random or completely on their way to the freight space in the airplane, in order to detect whether dangerous or endangering content is transported. The registered luggage is transferred to the airplane in isolation from the flight passenger and is then boarded. Hence, the flight passenger does not have a chance to take any dangerous objects from the registered luggage on board to his/her seat in the airplane.

Weapons are dangerous objects which are suited for threatening or injuring humans and thus are suited for hijacking an airplane, for instance bladed weapons (such as knifes) and firearms (such as nail gun devices, harpoons or crossbows).

When the flight passenger has dropped off his registered luggage, he/she proceeds to the corresponding departure gate to take a seat in the parking airplane. The departure gate is located in the airport security zone. The security zone can only be entered through a security gate, where a security check is performed. Said security check is performed for the flight passenger and the flight passenger's hand luggage. The flight passenger is inspected for dangerous objects on the body and in a further inspection hand luggage is scanned for dangerous objects. Hand luggage, in contrast to registered luggage, is taken into the security zone and is finally taken into the airplane.

Before the inspection of the flight passenger for dangerous objects on the body, the flight passenger puts all metallic objects to the hand luggage. For this purpose, watches, belts, shoes, key bunches and wallets are placed on a conveyor belt conveying the hand luggage through the security gate.

The inspection of the flight passenger for dangerous objects on the body takes place without any contact. Until recently, said check was performed exclusively with the use of metal detectors. Such metal detectors are moved by the security staff along the body to be inspected and emit a warning signal if there are any nearby metallic objects. Metal detectors can also be embodied as a gate to be passed through. Such metal detectors are afflicted with the problem that exclusively dangerous objects of metal are thereby detected. However, weapons of carbon fiber composite material, such as a knife of carbon fiber composite material, thereby are not detectable.

A material in which fabric mats of carbon fibers are embedded into a matrix of for instance epoxy is referred to as carbon fiber composite material. This material is extremely resilient and simultaneously a very lightweight material. For instance, knives being completely made of carbon fiber composite material with low weight are available on the market for application by mountaineers in an emergency case. Moreover, firearms, for instance in the form of a nail gun device, can also be produced from carbon fiber composite material.

So-called body scanners are increasingly used at airport security gates. Said body scanners employ terahertz radiation to detect objects hidden on the body. Electromagnetic radiation having frequencies between 0.1 and 10 terahertz, in other words between microwaves and infrared light, is referred to as terahertz radiation. A terahertz transmitter irradiates the human body, whereby terahertz radiation is reflected on the surface thereof. A receiver receives the reflected terahertz radiation for evaluation. Hence, objects can be detected which have a reflection for terahertz radiation which differs from the reflection of human skin. Terahertz radiation is reflected differently at electrically conductive objects of metal or carbon fiber composite material compared to human skin. Hence, weapons located on the human body and made of carbon fiber composite material can be detected. Body scanners pose the problem that all weapons not carried on the body in principle are excluded from the detection by the inspection.

In the conventional hand luggage check, the pieces of luggage are conveyed on a conveyor belt and are transilluminated by X-rays in a conveyance tunnel. Typically, for this purpose hand luggage is placed in a tray on a conveyor belt by the flight passenger. On said conveyor belt, hand luggage is then passed through a zone being transilluminated by an X-ray. There, a planar X-ray is directed to a detector, said detector being connected to an image output unit. The detector determines the absorption of the X-ray by objects being located in the piece of luggage. The image output unit generates a representation of the objects localized in the piece of luggage in a transillumination image due to the detected attenuation of the X-ray. For imaging, coherent objects are uniformly colored. In X-ray scanners there is the security problem that carbon fiber composite materials are not visible in said transillumination image. In tests with scanner devices which are using a radiant energy in the range of about 50 keV during operation 1-2 mm thick slices of a standard carbon plate material, or a carbon blades of Puma, are not visible. In the production of carbon fiber composite material, there are fiber blends of glass fiber and carbon fiber which are visible in the X-ray image, however, pure carbon fiber composite materials can be produced readily only with carbon fibers.

A security gap is therefore in that a criminal passenger who intends to hijack an airplane can take a weapon of carbon fiber composite material on board of an airplane by transporting the same in the hand luggage rather than carrying the same on the body.

Hence, it is an object of the present invention to provide a device for detecting weapons in a piece of luggage which overcomes the above-cited drawbacks and closes in particular the security gap that a criminal passenger may be able to smuggle a weapon of carbon fiber composite material into the security zone at an airport.

### SUMMARY

Disclosed are devices, methods, apparatus, and systems that provide a device for detecting weapons in a piece of luggage, the device may comprise a luggage placement unit for placement of a piece of luggage to be scanned, a first detection unit having an X-ray source and an X-ray detector, wherein said X-ray source may interact with the X-ray detector in such a manner that a weapon of an X-ray absorbing material may be detected at the luggage placement unit in a piece of luggage to be scanned, a second detection unit which may be adapted to detect a weapon of an X-ray non-absorbing material at the luggage placement unit in a piece of luggage to be scanned, and an output unit which may be for generating a signal when a weapon located in the piece of luggage may be detected by the first detection unit or the second detection unit. The device may also comprise wherein, the second detection unit may comprise a terahertz radiation source and a terahertz radiation detector which may interact in such a manner that a weapon of carbon fiber composite material may be detected at the luggage placement unit in the piece of luggage to be scanned. The device additionally may comprise wherein the second detection unit comprises a reflector, wherein said reflector may be arranged such that terahertz radiation emanating from the terahertz radiation source may be directed into the terahertz radiation detector. The device also may further comprising a casing tunnel in which the first detection unit and the second detection unit are arranged, and wherein the luggage placement unit comprises a conveyor belt for conveying a piece of luggage to be scanned through the casing tunnel. In addition, the device may comprise, wherein the first detection unit may be arranged in the conveying direction of the conveyor belt in front of the second detection unit and also wherein the output unit may include a screen for displaying an image generated by the output unit of the weapon detected in the piece of luggage. Further, the device may comprise, wherein the output unit may include an image processing unit for comparing several images generated by the output unit of the weapon located in the piece of luggage, as well as, wherein the image processing unit may compare an image of the piece of luggage from the inspection by the first detection unit and an image of the piece of luggage from the inspection by the second detection unit. The device may further comprise, wherein the output unit may include a warning unit which may be adapted to emit a warning signal if an image of the piece of luggage from the inspection by the first detection unit does not show a weapon and an image of the piece of luggage from the inspection by the second detection unit does show a weapon. In an embodiment the device may comprise a security gate comprising a body scanner for inspecting people for the carrying of weapons on the body and a device for detecting weapons in a piece of luggage.

The methods and systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, in which, like references indicate similar elements.

FIG. 1 is a side view of an embodiment of the present invention device for detecting weapons in a piece of luggage.

Other features of the present embodiments will be apparent from the accompanying drawings and from the detailed description that follows.

### DETAILED DESCRIPTION

This object of the invention is attained by a device for detecting weapons in a piece of luggage according/Advantageous embodiments are the object of the respective dependent claims.

The invention pertains to a device for detecting weapons in a piece of luggage, said device comprising a luggage placement unit onto which a piece of luggage to be scanned can be placed, a first detection unit having an X-ray source and an X-ray detector, wherein said X-ray source interacts with the X-ray detector in such a manner that a weapon of an X-ray absorbing material is detected at the luggage placement unit in a piece of luggage to be scanned, and a second detection unit which is adapted to detect a weapon of an X-ray non-absorbing material at the luggage placement unit in a piece of luggage to be scanned, and an output unit for generating a signal when a weapon located in the piece of luggage is detected by the first detection unit or the second detection unit.

The hand luggage is placed in the luggage placement unit and the first detection unit having the X-ray source and the X-ray detector generates a transillumination image of the content of the hand luggage. Such transillumination images are based on the attenuation of X-rays. A weapon of an X-ray non-absorbing material, such as carbon fiber composite material, is not detected by the first detection unit. The second detection unit detects a weapon of an X-ray non-absorbing material at the luggage placement unit in a piece of luggage to be inspected. Thereby, other objects of an X-ray non-absorbing material can also be detected. Inspection by security staff then finally reveals whether a weapon has been detected or not.

The described device closes the security gap, which enables a criminal passenger to smuggle a weapon of carbon fiber composite material into the security zone at an airport, by detection of a weapon of carbon fiber composite material in the hand luggage. The weapon is detected even when the criminal passenger does not carry the weapon of X-ray non-absorbing material on the body, but instead transports it in the hand luggage. In any case, the mere recognition of an object of an X-ray non-absorbing material may give cause for inspection of the piece of luggage by the security staff to detect a weapon of an X-ray non-absorbing material. Every object of an X-ray non-absorbing material may firstly be classified as a weapon. X-ray non-absorbing material is any material which is not imaged in the X-ray transillumination, i.e. for instance carbon fiber composite material.

In a preferred example, the second detection unit for this purpose comprises a terahertz radiation source and a terahertz radiation detector which interact in such a manner that a weapon of carbon fiber composite material is detected at the luggage placement unit in the piece of luggage to be inspected. Carbon fiber composite material is an example of an X-ray non-absorbing material. For this purpose, comparable to a body scanner, the reflected terahertz radiation is received in the terahertz radiation detector. For instance, in this regard imaging methods known from the visualization of three-dimensional objects on the human body can be employed (DE 10 2012 006 670 A1).

Particularly preferably, the second detection unit comprises a reflector. Said reflector is adapted and arranged to direct terahertz radiation emanating from a terahertz radiation source into the terahertz radiation detector (similarly as the body surface in the body scanner). The reflector in the simplest case is an electrically conductive board having a (constant) conductivity over the entire surface thereof. Particularly preferably, the board has an electrical conductivity differing from that of the carbon fiber composite material in such a manner that objects generate a readily visible shade thereof.

Preferably, the device comprises a casing tunnel in which the first detection unit and the second detection unit are arranged. The luggage placement unit comprises a conveyor belt for conveying a piece of luggage to be inspected through the casing tunnel. Said casing tunnel can be employed as a shielding against exiting X-ray radiation from the first detection unit.

Preferably, the first detection unit is arranged in the conveyance direction of the conveyor belt in front of the second detection unit. In this arrangement, firstly a weapon of X-ray absorbing material can be detected. Then, it is checked whether a weapon of an X-ray non-absorbing material is located therein. Moreover, if an object is found in the second check in the place, where an object was not found in the first check, it can be concluded that an object of an X-ray non-absorbing material is present. This finding alone would give cause for a mandatory manual inspection of the piece of luggage for weapons.

According to a preferred aspect of the device, the output unit includes a screen to display an image generated by the output unit of the weapon detected in the piece of luggage. The graphical output can further comprise an image processing. Thus, for instance in X-ray transillumination, areas of same shielding can be colored identically.

According to an advantageous aspect it is provided that the output unit comprises an image processing unit to compare several images generated by the output unit of the weapon located in the piece of luggage. Hence, different images from the first detection unit and the second detection unit can be “superimposed” and compared.

Preferably, the image processing unit graphically processes an image of the weapons detected by the first detection unit in the piece of luggage and an image of the weapons detected by the second detection unit in the piece of luggage to localize an object of an X-ray non-absorbing material in a place, where nothing could be seen in the check by the first detection unit, however, where something could be seen in the check by the second detection unit.

Another aspect provides that the output unit comprises a warning unit which is adapted to emit a warning signal if an image generated by the output unit of the first detection unit does not image a weapon located in the piece of luggage and an image generated by the output unit of the second detection unit images a weapon located in the piece of luggage. Hence, a warning signal is generated if weapons of an X-ray non-absorbing material are detected.

According to another aspect, the invention relates to a security gate comprising a body scanner for investigating persons for the carrying of weapons on the body and a device for detecting weapons in a piece of luggage as described herein.

Although the present embodiments have been described with reference to specific example embodiments, it will be evident that various modifications and changes may be made to these embodiments without departing from the broader spirit and scope of the various embodiments. It should be understood by one of ordinary skill in the art that the terms describing processes, products, elements, or methods are industry terms and may refer to similar alternatives In addition, the components shown in the figures, their connections, couples, and relationships, and their functions, are meant to be exemplary only, and are not meant to limit the embodiments described herein.

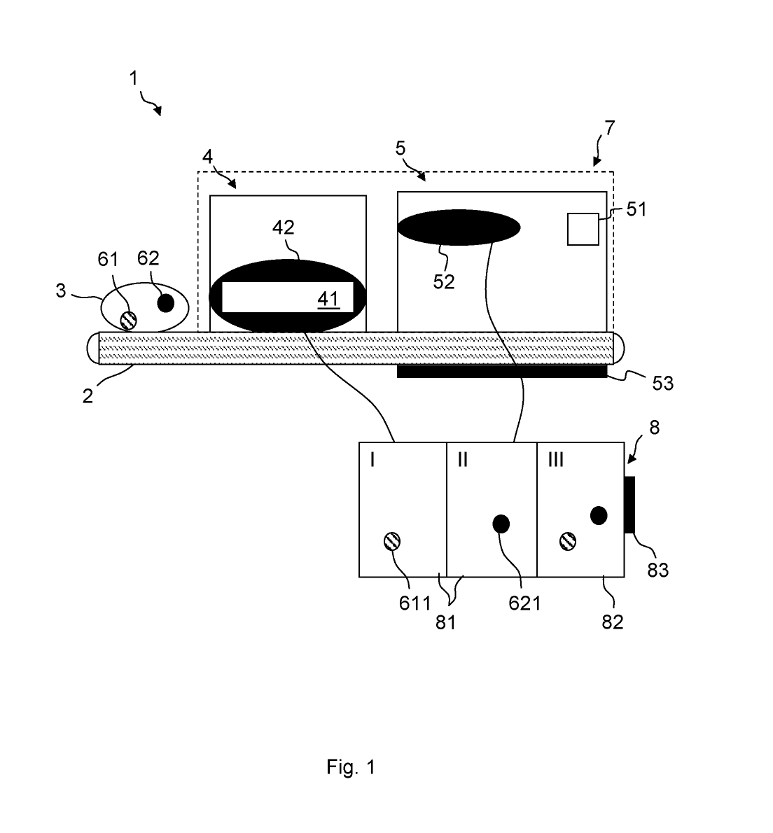

In the following, the invention will be described exemplarily with reference to FIG. 1. FIG. 1 shows a device 1 for detecting weapons of an X-ray absorbing material 61 and for detecting weapons of an X-ray non-absorbing material 62 in a piece of luggage 3 for instance for the hand luggage at an airport. The device 1 has a conveyor belt 2 as a luggage placement unit onto which a piece of luggage 3 to be inspected for the content of weapons is placed.

The device 1 further comprises a first detection unit 4 having an X-ray source 41 and an X-ray detector 42. The X-ray source 41 interacts with the X-ray detector in such a manner that a weapon 61 of an X-ray absorbing material is detected at the luggage placement unit 2 in a piece of luggage 3 to be scanned. For this purpose, a transillumination image is generated due to the absorption of the X-ray emanating from the X-ray source 41 and entering directly into the X-ray detector 42.

The device 1 further comprises a second detection unit 5 which is adapted to detect a weapon 62 of an X-ray non-absorbing material in the piece of luggage 3 to be inspected by providing a terahertz radiation source 51 and a terahertz radiation detector 52. For instance, for this purpose, imaging methods known from the visualization of three-dimensional objects on the body of humans (DE 10 2012 006 670 A1) can be implemented in the second detection unit. In the present example, the device 1 further comprises a reflector 53 which reflects terahertz radiation from the terahertz radiation source 51 into the terahertz radiation detector 52 with uniform intensity. Thus, the detected background of terahertz radiation is rendered uniform and weapons (objects) of different reflectivity can be distinguished.

If, for instance a knife of carbon fiber composite material (as an example for a weapon 62 of X-ray non-absorbing material) is located in the piece of luggage 3, the reflection thereof of terahertz radiation can be detected as a deviation with respect to the background. Different reflections result from different electrical properties (such as conductivities of the surface).

The device 1 further comprises a casing tunnel 7 in which the first detection unit 4 and the second detection unit 5 are arranged. The piece of luggage 3 to be inspected is conveyed on the conveyor belt 2 through the casing tunnel 7.

The output unit 8 generates an image of the piece of luggage 3 from the first detection unit 4 and an image of the piece of luggage 3 of the second detection unit 5 which is displayed on a screen 81. Using an image processing unit 82 both images 611 can be graphically compared to determine whether an object (weapon) of an X-ray non-absorbing material is located in the piece of luggage. The output unit 8 comprises a warning unit 83 which emits an acoustic warning signal if an object (weapon) of an X-ray non-absorbing material is visible. If an (in particular isolated) object of an X-ray non-absorbing material is detected, for the sake of security, the presence of a weapon is always assumed and manual inspection by security staff is required.

The device 1 closes the security gap, which enables a criminal passenger to smuggle a weapon 62 of carbon fiber composite material into the security zone at an airport, by the detection of a weapon 62 of carbon fiber composite material in the hand luggage 3. The weapon is detected even when the criminal passenger does not carry the weapon 62 of carbon fiber composite material on the body, but instead transports it in the hand luggage 3.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A device for detecting weapons in a piece of luggage, the device comprising:
a luggage placement unit for placement of a piece of luggage to be scanned,
a first detection unit having an X-ray source and an X-ray detector, wherein said X-ray source interacts with the X-ray detector in such a manner that a weapon of an X-ray absorbing material is detected at the luggage placement unit in a piece of luggage to be scanned,
a second detection unit which is adapted to detect a weapon of an X-ray non-absorbing material at the luggage placement unit in a piece of luggage to be scanned, and
an output unit for generating a signal when a weapon located in the piece of luggage is detected by the first detection unit or the second detection unit.

2. The device according to claim 1, wherein the second detection unit comprises a terahertz radiation source and a terahertz radiation detector which interact in such a manner that a weapon of carbon fiber composite material is detected at the luggage placement unit in the piece of luggage to be scanned.

3. The device according to claim 2, wherein the second detection unit comprises a reflector, wherein said reflector is arranged such that terahertz radiation emanating from the terahertz radiation source is directed into the terahertz radiation detector.

4. The device according to claim 1, further comprising a casing tunnel in which the first detection unit and the second detection unit are arranged, and wherein the luggage placement unit comprises a conveyor belt for conveying a piece of luggage to be scanned through the casing tunnel.

5. The device according to claim 4, wherein the first detection unit is arranged in the conveying direction of the conveyor belt in front of the second detection unit.

6. The device according to claim 1 wherein the output unit includes a screen for displaying an image generated by the output unit of the weapon detected in the piece of luggage.

7. The device according to claim 6, wherein the output unit includes an image processing unit for comparing several images generated by the output unit of the weapon located in the piece of luggage.

8. The device according to claim 7, wherein the image processing unit compares an image of the piece of luggage from the inspection by the first detection unit and an image of the piece of luggage from the inspection by the second detection unit.

9. The device according to claim 8, wherein the output unit includes a warning unit which is adapted to emit a warning signal if an image of the piece of luggage from the inspection by the first detection unit does not show a weapon and an image of the piece of luggage from the inspection by the second detection unit does show a weapon.

10. The device according to claim 1, wherein a security gate comprising a body scanner for inspecting people for the carrying of weapons on the body and a device for detecting weapons in a piece of luggage.
